(19) United States
(12) Patent Application Publication
(10) Pub. No.: US 2019/0343312 A1
(43) Pub. Date: Nov. 14, 2019

(54) PLASTIC TIPPED BIODEGRADABLE STRAW

(71) Applicant: Kelly Bryson Rhymer, Hendersonville, NC (US)

(72) Inventor: Kelly Bryson Rhymer, Hendersonville, NC (US)

(21) Appl. No.: 16/272,137

(22) Filed: Feb. 11, 2019

Related U.S. Application Data
(60) Provisional application No. 62/669,206, filed on May 9, 2018.

(51) Int. Cl. A47G 21/18

(52) U.S. Cl. CPC A47G 21/186; C08L 2201/06

(57) ABSTRACT

A straw includes a body having a tube shape with an open top end and an open bottom end leading into the hollow tube. The body is made of a biodegradable paper material. The straw further includes a tip having a tube shape with a top portion having an open top end and a bottom portion having an open bottom end both leading into the hollow tube. An adjustable portion is disposed between the top portion and the bottom portion. The tip is made of a plastic material. The open bottom end of the tip is coupled to the open top end of the body, fluidly connecting the body 16 to the tip.

### CROSS-REFERENCE TO RELATED APPLICATION

This application claims the benefit of priority of U.S. provisional application No. 62/669,206, filed May 9, 2018, the contents of which are herein incorporated by reference.

### BACKGROUND OF THE INVENTION

The present invention relates to straws and, more particularly, to a plastic tipped biodegradable straw.

Plastic straws are convenient and do not collapse while being used. However, plastic straws are not biodegradable, and a large number of used plastic straws pollute our oceans. Biodegradable paper straws are better for the environment but degrade and collapse during use.

As can be seen, there is a need for a biodegradable straw that does not degrade and collapse during use.

### SUMMARY OF THE INVENTION

In one aspect of the present invention, a straw comprises: a body comprising a tube shape having an open top end and an open bottom end, wherein the body is made of a biodegradable paper material; and a tip comprising a tube shape having a top portion having an open top end, a bottom portion having an open bottom end, and an adjustable portion disposed between the top portion and the bottom portion, wherein the tip is made of a plastic material, wherein the open bottom end of the tip is coupled to the open top end of the body, fluidly connecting the body to the tip.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of an embodiment of the present invention, illustrating flexibility;

FIG. 3 is a side view of an embodiment of the present invention;

FIG. 4 is a detailed section view taken along line 4-4 of FIG. 2; and

FIG. 5 is a detailed section view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a combination of a plastic tip and a biodegradable paper body to form a combination plastic and paper straw. The plastic and paper straw combination solves the durability and texture issues of a fully biodegradable plastic straw. The plastic and paper straw combination also provides an earth friendly solution, since the present invention uses a reduced amount of plastic when comparted to a fully plastic straw.

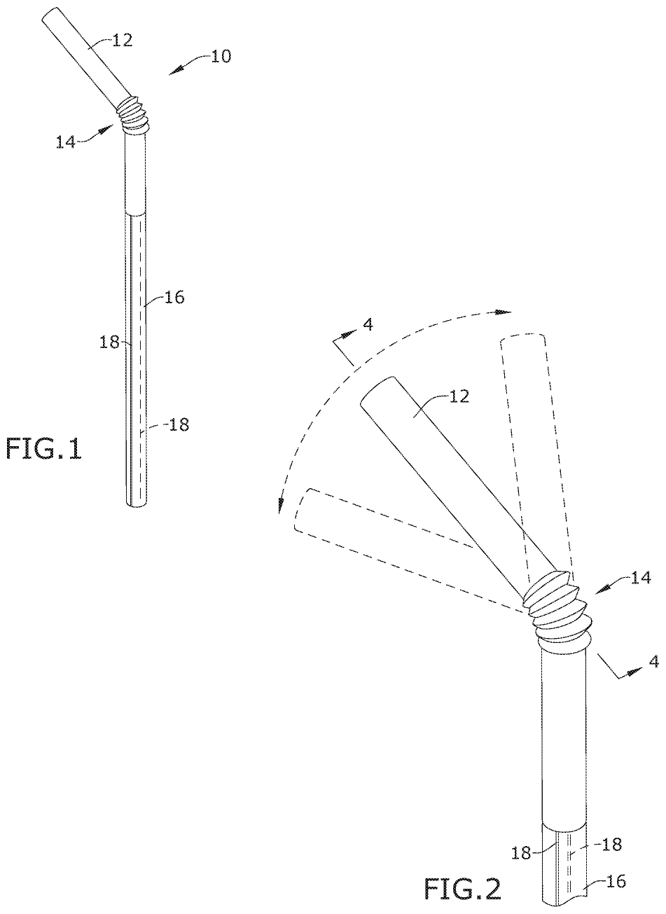

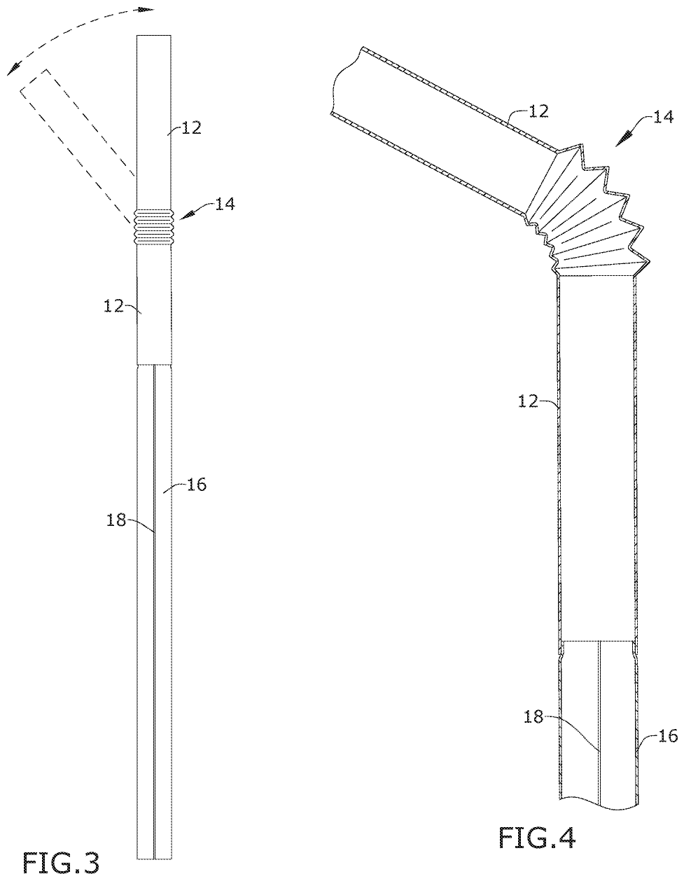

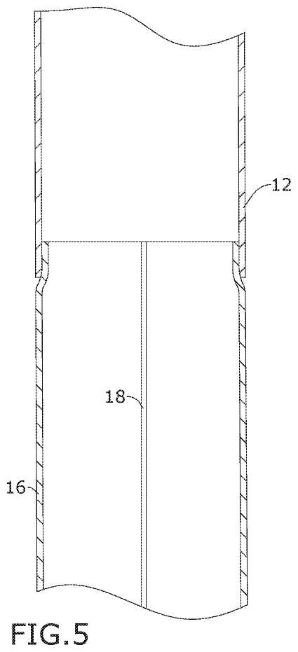

Referring to FIGS. 1 through 5, the present invention includes a straw 10. The straw 10 includes a body 16 having a tube shape with an open top end and an open bottom end leading into the hollow tube. The body 16 is made of a biodegradable paper material. The straw 10 further includes a tip 12 having a tube shape with a top portion having an open top end and a bottom portion having an open bottom end both leading into the hollow tube. An adjustable portion 14 is disposed between the top portion and the bottom portion. The tip 12 is made of a plastic material. The open bottom end of the tip 12 is coupled to the open top end of the body 16, fluidly connecting the body 16 to the tip 12.

As mentioned above, the body 16 is an elongated tube having a hollow core. In certain embodiments, the body 16 includes a support ridge 18 running along the length of the body 16. For example, the body 16 may include two support ridges 18 running along opposing sides of the body 16. The support ridges 18 may include thicker paper material to maintain the body's 16 integrity while in use. In certain embodiments, the open top end of the body 16 includes necked down portion in which the diameter is reduced. The open bottom end of the tip 12 fits over the necked down portion and is sealed to the body 16.

The tip 12 of the present invention also includes a tube having a hollow core. The tip 12 is made of a plastic material, such as a biodegradable plastic. As mentioned above, the tip 12 includes a top portion joined to a bottom portion by an adjustable portion 14. The adjustable portion 14 may adjust the length of the tip 12 and may further allow the top portion to rotate relative to the bottom portion. As illustrated in the Figures, the adjustable portion 14 may include an accordion. The accordion includes an extended configuration and a retracted configuration. The extended configuration increases the length of the tip 12, and the retracted configuration decreases the length of the tip 12.

It should be understood, of course, that the foregoing relates to exemplary embodiments of the invention and that modifications may be made without departing from the spirit and scope of the invention as set forth in the following claims.

What is claimed is:

1. A straw comprising:
a body comprising a tube shape having an open top end and an open bottom end, wherein the body is made of a biodegradable paper material; and
a tip comprising a tube shape having a top portion having an open top end, a bottom portion having an open bottom end, and an adjustable portion disposed between the top portion and the bottom portion, wherein the tip is made of a plastic material, wherein
the open bottom end of the tip is coupled to the open top end of the body, fluidly connecting the body to the tip.

2. The straw of claim 1, wherein the open top end of the body comprises necked down portion, wherein the open bottom end of the tip fits over the necked down portion and is sealed to the body.

3. The straw of claim 1, wherein the adjustable portion is an accordion comprising an extended configuration and a retracted configuration, wherein the extended configuration increases the length of the tip, and the retracted configuration decreases the length of the tip.

4. The straw of claim 1, wherein the body further comprises a support ridge running along a length of the body.

5. The straw of claim 1, wherein the plastic material of the tip is a biodegradable plastic.
